(19) United States
(12) Patent Application Publication
(10) Pub. No.: US 2001/0017361 A1
(43) Pub. Date: Aug. 30, 2001

(54) Tap

(75) Inventors: Leon Kerger, Helmdange (LU); Jean-Claude Schmitz, Heisdorf (LU)

Correspondence Address: LEYDIG VOIT & MAYER, LTD, 6815 WEAVER ROAD, ROCKFORD, IL, 61114-8018, US

(73) Assignee: Torrent Trading Ltd., Tortola (VG)

(21) Appl. No.: 09/770,903

(22) Filed: Jan. 26, 2001

(30) Foreign Application Priority Data
Feb. 10, 2000 (LU) 90 520

(51) Int. Cl. F16K 31/50

(52) U.S. Cl. 251/288

(57) ABSTRACT

The tap intended for controlling the flow of a fluid, for example of a gas, comprises a tap body (34), an inner member (36) for opening and closing the passage of the gases, an outer rotary operating handwheel (42), a connection means (40) connecting the operating handwheel (42) to the closing member (36) and means limiting the movement of the operating handwheel (42) and of the opening and closing member (36) in the opening direction of the tap. In order to avoid the tap becoming jammed in the open position, said means limiting the movement of the operating member consist of an abutment (44) and a counterabutment (46) with frontal contact, which are arranged respectively on a rotary element and on the body (34) of the tap, or vice versa.

### FIELD OF THE INVENTION

The present invention relates to a tap for controlling the flow of a fluid, comprising a tap body, an inner member for opening and closing the passage of the fluid, an outer rotary operating member, a connection means connecting the operating member to the closing member and means limiting the movement of the operating member and of the opening and closing member in the opening direction of the tap.

### BACKGROUND OF THE INVENTION

Although not being limited to this, the invention relates, more particularly, to a tap for bottles or tanks containing compressed or liquefied gas. In this type of tap, the connection means may be a rod and the means for limiting the movement in the opening direction generally consist of one or two spindles passing through the body of the tap in the transverse direction perpendicularly to the movement of the rod and tangentially relative to the latter. For this purpose, the rod comprises, in its central region, an annular contraction allowing the passage of the two spindles and the rotation of the rod. These two spindles and the base of the contraction form abutments and counterabutments defining the end of travel of the rod and the stopping of the opening movement of the tap.

The disadvantage of this known system is that, at the end of movement and since the tap is generally opened fully, the two spindles approach the bottom of the contraction of the rod tangentially on account of the rotation of the rod. Consequently, contact between the rod and the spindle or spindles is frictional or rubbing contact, that is to say progressive clamping and even jamming of the tap in the opening position occurs.

This clamping or jamming of the tap requires a great amount of manual force when the tap is to be closed and prompts the use of a tool, such as pliers. This may, however, give rise to carelessness and has already caused accidents on opening the tap. To be precise, it has already happened that an operator, wanting to release the tap by means of a tool, has turned the operating member in the wrong direction, that is to say in the opening direction, until the head of the tap has fractured. This may obviously present a serious risk if the gases are toxic or explosive.

### SUMMARY OF THE INVENTION

The object of the present invention is to provide a novel tap of the type described in the introduction, which does not have this disadvantage, that is to say a tap without the risk of clamping or jamming when the tap is opened fully.

In order to achieve this object, the invention proposes a tap of the type described in the introduction, which is characterized in that said means limiting the movement of the operating member consist of an abutment and a counterabutment with frontal contact, which are arranged respectively on a rotary element and on the body of the tap, or vice versa.

Since there is no frictional contact between the abutment and counterabutment, there is no risk that the tap will become clamped or jammed. The operator can easily close the tap without exerting excessive force and without risking making a mistake over the direction of rotation and tightening the tap even more.

During opening and at the penultimate turn in the rotation of the operating member, the abutment and counterabutment do not yet come into contact, which means that, when they stop the rotation of the operating member, they are in mutual contact over a height which is smaller than the pitch of the threads between the rotary elements and the body of the tap.

### BRIEF DESCRIPTION OF THE DRAWINGS

Other particular features and characteristics of the invention may be gathered from the detailed description of an embodiment given below by way of illustration, with reference to the accompanying drawings in which:

FIG. 1 is a vertical section through a known tap;

FIG. 2 is a vertical section through a tap according to the present invention, and

FIG. 3 is a horizontal section through the tap of FIG. 2 along the sectional plane III-III.

### DETAILED DESCRIPTION OF THE PREFERRED EMBODIMENTS

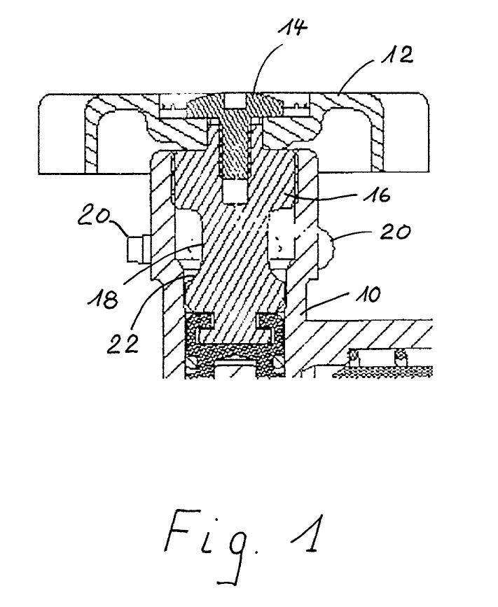

The known tap in FIG. 1, of which only the elements necessary for understanding the problem have been illustrated, comprises a tap body 10, preferably made of metal, for example bronze. The tap is actuated by means of an operating handwheel 12 which is fastened with the aid of a central screw 14 to a rod 16 screwed into the upper part of the body 10. On the opposite side to the handwheel 12, the rod 16 is connected directly or indirectly to the closing member, not shown, of the tap. Rotation of the member 12 consequently generates an axial movement of the rod 16 and of the closing member.

As shown in FIG. 1, the rod 16 comprises, in its middle region, an annular contraction 18 of a diameter smaller than that of the head of the rod 16. Moreover, one or preferably two spindles 20 are fastened transversely in the wall of the body 10 of the tap and pass through this contraction 18. These spindles 20 prevent the rod 16 from being unscrewed completely and form a stop abutment during the opening of the tap as a result of contact between the bottom 22 of the contraction and the spindles 20. For this purpose, the bottom 22 is rounded according to the curvature of the spindles 20.

However, as explained in the introduction, when the tap is opened, the bottom 22 of the contraction does not come into abutment on the spindles, but, because of the rotation of the rod, tangential frictional or shearing contact occurs between the rod 16 and the spindles 20, and this may give rise to excessive clamping or jamming of the tap in the opening position.

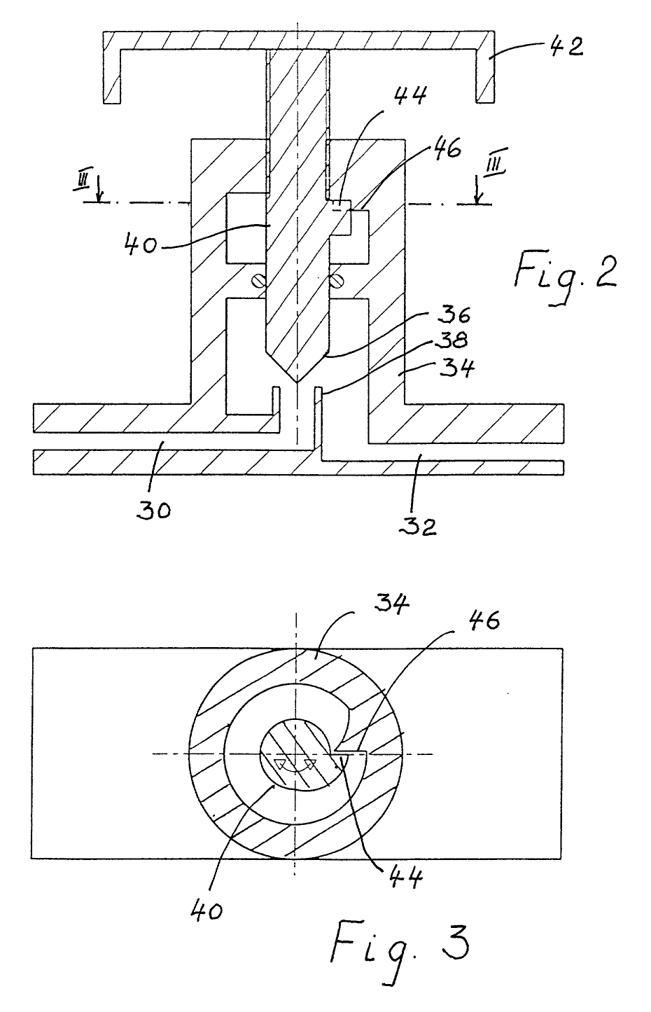

To overcome this disadvantage, the invention has proposed a novel tap, one embodiment of which is illustrated by way of example in FIGS. 2 and 3. This tap is intended for opening and closing communication between two pipes 30 and 32. The tap comprises a body 34, in which is located an opening and closing member 36 co-operating with a seat 38. The closing member 36 forms the lower part of a connecting rod 40 which is arranged axially in the body 34 and which is integral with an operating handwheel 42 outside the tap. The upper part of the connecting rod 40 is provided with an external thread co-operating with a corresponding thread in the head of the body 34, with the result that a rotation of the handwheel 42 causes the rod 40 to rise or fall, depending on the direction of rotation.

According to the present invention, the connecting rod comprises an outer radial abutment 44, whilst the body 34 comprises an inner radial counterabutment 46. The abutment 44 and the counterabutment 46 are arranged in such a way that, during the rotation of the connecting rod 40, the abutment 44 passes below the counterabutment 46 at the penultimate turn in the rotation of the handwheel 42 in the opening direction. By contrast, at the end of the last rotational turn and after the rise over a height corresponding to the pitch of the thread of the upper part of the connecting rod 40, the abutment 44 butts on the counterabutment 46, as illustrated in FIG. 2. The abutment 44 consequently strikes the counterabutment 46 perpendicularly without any friction and without the risk of clamping or jamming.

The location of the abutment 44 and of the counterabutment 46 is only one example of implementation. The abutment 44 could, for example, be provided on the inner face of a peripheral skirt of the handwheel 42 and the counterabutment could be provided on the outer surface of the body 34.

The abutment 44 and the counterabutment 46, instead of forming an integral part of the rod 40 and of the body 34 respectively, this part being obtained, for example, by machining, could be formed by pins made integral with these components.

Moreover, the rod 40 could be smooth over its entire height, and its axial movement could be generated by means of a thread provided on the inner face of a cylindrical skirt integral with the handwheel 42 and cooperating with a corresponding thread outside the body 34.

Finally, the handwheel could be replaced by a polygonal head which would be actuated by means of a special spanner.

What is claimed is:

1. Tap for controlling the flow of a fluid, comprising a tap body (34), an inner member (36) for opening and closing the passage of the fluid, an outer rotary operating member (42), a connection means (40) connecting the operating member (42) to the closing member (36) and means limiting the movement of the operating member (42) and of the opening and closing member (36) in the opening direction of the tap, characterized in that said means limiting the movement of the operating member comprises an abutment (44) and a counterabutment (46) with frontal contact, which are arranged respectively on a rotary element and on the body of the tap (34), or vice versa.

2. Tap according to claim 1, characterized in that the abutment (44) is arranged on a connecting rod (40) between the operating member (42) and the closing member (36) and the counterabutment (46) is arranged on the inner wall of the body (34) of the tap.
